(19) United States
(12) Patent Application Publication
(10) Pub. No.: US 2026/0097472 A1
(43) Pub. Date: Apr. 9, 2026

(54) PIVOTING DRIVER

(71) Applicant: Bow Products, Inc., Superior, CO (US)

(72) Inventor: D. Keith Bow, Corfu, NY (US)

(73) Assignee: Bow Products Inc, Superior, CO (US)

(21) Appl. No.: 19/346,205

(22) Filed: Sep. 30, 2025

Related U.S. Application Data
(60) Provisional application No. 63/704,897, filed on Oct. 8, 2024.

(51) Int. Cl. B25B 23/00; B25B 15/04

(52) U.S. Cl. CPC B25B 23/0028; B25B 15/04; B25B 23/0035; B25B 23/0042

(57) ABSTRACT

A pivoting driver includes a pivotable shaft where at least the handle can be pivoted relative to the shaft to provide increased leverage and torque when turning the shaft to tighten or loosen a fastener.

This application claims priority under 35 U.S.C. § 119(e) to U.S. Provisional Patent Application No. 63/704,897, for a PIVOTING DRIVER, filed Oct. 8, 2024 by D. Keith Bow, which is hereby incorporated by reference in its entirety.

A driver, for use in tightening or loosening a fastener such as a cap screw, includes a pivotable shaft so that at least the handle can be pivoted relative to the shaft to provide increased leverage and torque when turning the shaft to tighten and loosen a fastener.

### BACKGROUND AND SUMMARY

Various types of tools are known for use in tightening and loosening fasteners, including cap screws and others that may be used to connect or anchor devices to a work surface or table. Such tools include conventional L-shaped Allen-wrenches as well as T-shaped drivers (e.g., hex keys), screwdrivers (handle and shaft) and the like. Each driver tool has a particular operation that it is adapted to. For example, a screwdriver is well adapted to quickly turning a fastener, although limited in the amount of force (torque) that can be applied to the fastener, which can be used to tighten the fastener or loosen a fastener that is stuck. Conversely, an Allen-wrench or hex key allows for the application of greater force (torque) to a fastener, but it is often difficult to quickly turn the fastener using such tools.

The pivoting driver disclosed herein provides a tool that is capable of being reconfigured by pivoting the handle relative to its shaft, in order to adapt and provide the advantages of multiple tools. In other words, the pivoting driver can be easily and quickly reconfigured to adapt to the user's need-providing both the quick turning of a straight screwdriver as well as the added leverage and torque of an Allen-wrench or hex key.

Disclosed in embodiments herein is a hand-held pivoting driver including: an elongated handle; and an elongated shaft pivotably connected to and extending from the handle, wherein the handle can be used to apply torque to the shaft in both a first orientation along a longitudinal axis of the shaft and a second orientation generally perpendicular to the longitudinal axis of the shaft.

Further disclosed in embodiments herein is a hand-held driver including: a handle; and a shaft pivotably connected to and extending from the handle, wherein the handle can be used to apply torque to the shaft in both a first orientation along a longitudinal axis of the shaft and a second orientation generally perpendicular to the longitudinal axis of the shaft.

### BRIEF DESCRIPTION OF THE DRAWINGS

FIGS. 1A-1B are cross-sectional views of one embodiment of the pivoting driver;

FIG. 2 is an assembly view of the embodiment of FIGS. 1A-1B;

FIG. 3A is a side view of the embodiment of FIGS. 1A-1B with detail of a tension spring used to retract the driver shaft, and FIG. 3B is an alternative configuration employing a compression spring to retract the driver shaft;

FIGS. 4A-4B, 5A-5C and 6A-6B are engineering drawing representations with details of various components of the embodiment and alternatives of FIGS. 1A-3;

FIGS. 7A-7C are illustrations of the functionality of the pivoting driver;

FIGS. 8A-8H are sequential images depicting an exemplary use of the pivoting driver embodiment of FIGS. 1A-7C;

FIGS. 9A-12C are illustrations depicting alternative embodiments and additional features of the pivoting driver;

FIGS. 13A-13C are illustrations of alternative mechanisms and features that may be used to releasably position the pivoting shaft at various additional angles;

FIG. 14 is an illustrative representation of five views of the various use configurations of the pivoting driver; and

FIGS. 15A-15C are illustrations of alternative embodiments and associated components of the pivoting driver.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

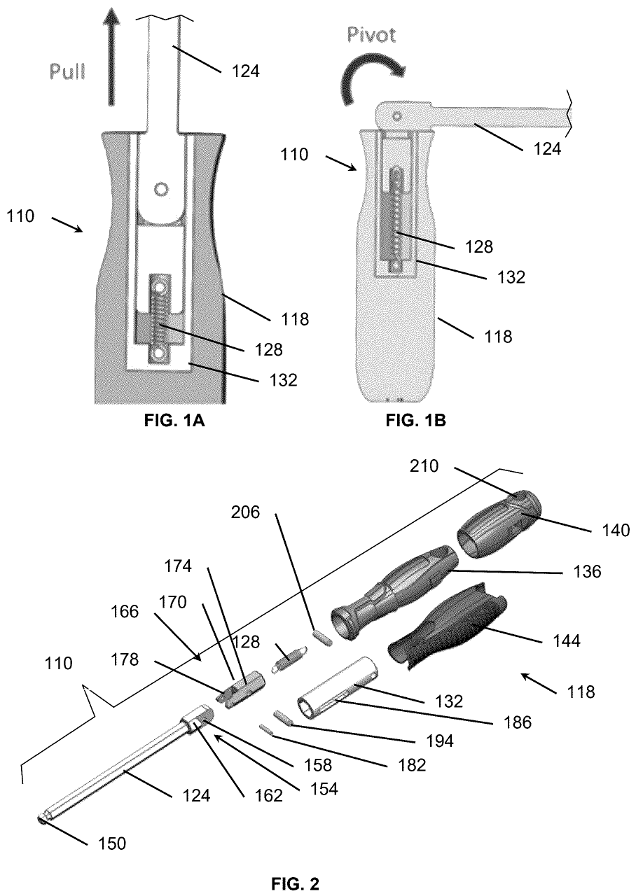

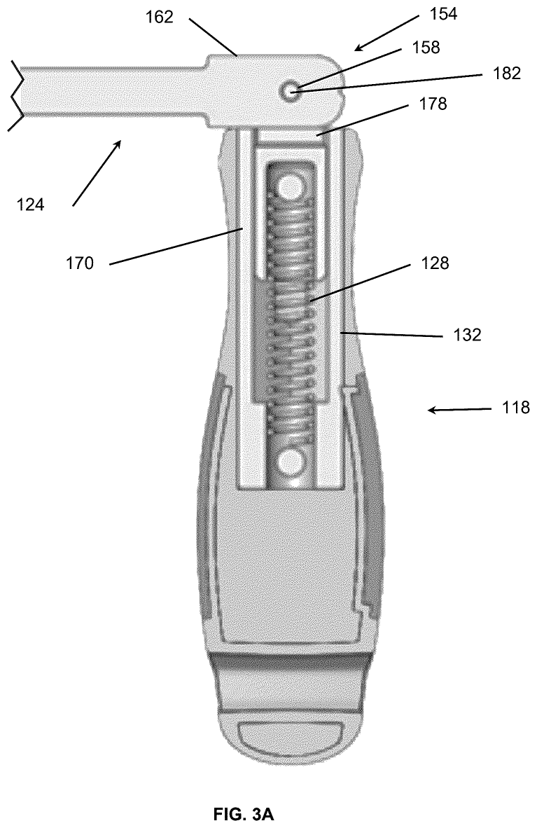

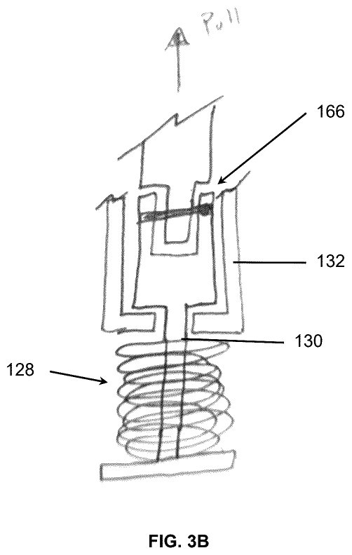

Referring to FIGS. 1A-3B, depicted therein are various views of an improved pivoting driver 110 for use in tightening or loosening a fastener such as a cap screw, where the driver includes a pivotable shaft so that at least the handle can be pivoted relative to the shaft to provide increased leverage when turning the shaft and fastener. In the recessed embodiment depicted, the hand-held driver 110 includes an elongated handle 118 and an elongated shaft 124 that is pivotably connected to and extends from the handle. As illustrated in FIGS. 1B and 3A, the pivoted orientation illustrates how handle 118 can be changed from being co-linear with the shaft to pivoted relative to the shaft. The pivoted orientation, with handle 118 generally perpendicular to the longitudinal axis of the shaft 124, allows a user to apply greater torque to the shaft, and thus to any fastener that the shaft head engages.

As will now be described in detail, in one embodiment the elongated shaft 124 of the driver may be slidably inserted or retracted into the handle 118. For example, one end of the elongated shaft 124 may be partially retained within the handle by a biasing (spring) member 128. More specifically, the handle 118 includes a partially hollow main handle 136 to which the slider housing 132 is affixed in a first end, a bottom handle 140 that covers a portion of the main handle including a second end opposite the first end, and a grip surface such as a rubber overmolding 144 that is applied over the main handle and bottom handle to provide the grip surface. The outside of slider housing 132 is affixed within and to the main handle 140, and the inside of the slider housing has a cross-sectional shape defined by a plurality of adjacent planar surfaces to form a hexagonal opening.

With regard to the cross-sectional shape, it should be appreciated that other cross-sectional shapes such as a rectangle, pentagonal, octagonal, etc. may be used for the inner or interior shape of the slider housing. Moreover, other polygonal shapes including stars, splines, Ts and Xs may also be used, as well as curvilinear shapes, so long as the shape of the cross-section is non-circular or otherwise prevents the shaft 124 from rotating inside the slider housing 132. For example, although not depicted, also contemplated is a shaft and slider-housing combination that incorporates a pawl or similar ratcheting mechanism, which permits the driver handle 118 to selectably rotate in an either a clockwise or counter-clockwise direction relative to the shaft and then lock or engage a pawl to allow the application of a torque force in the opposite direction.

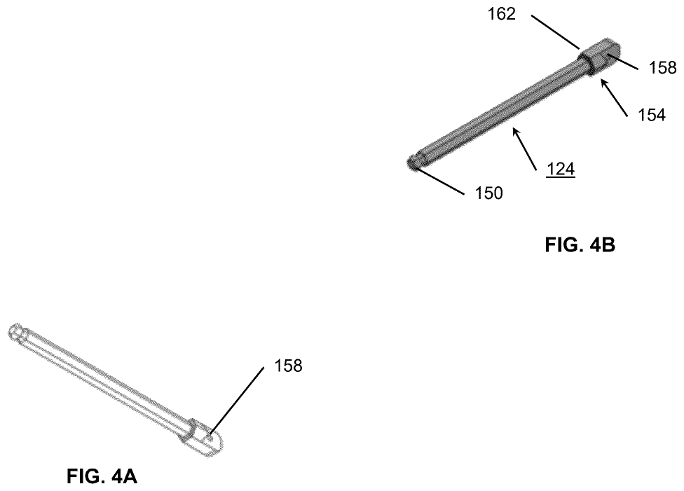

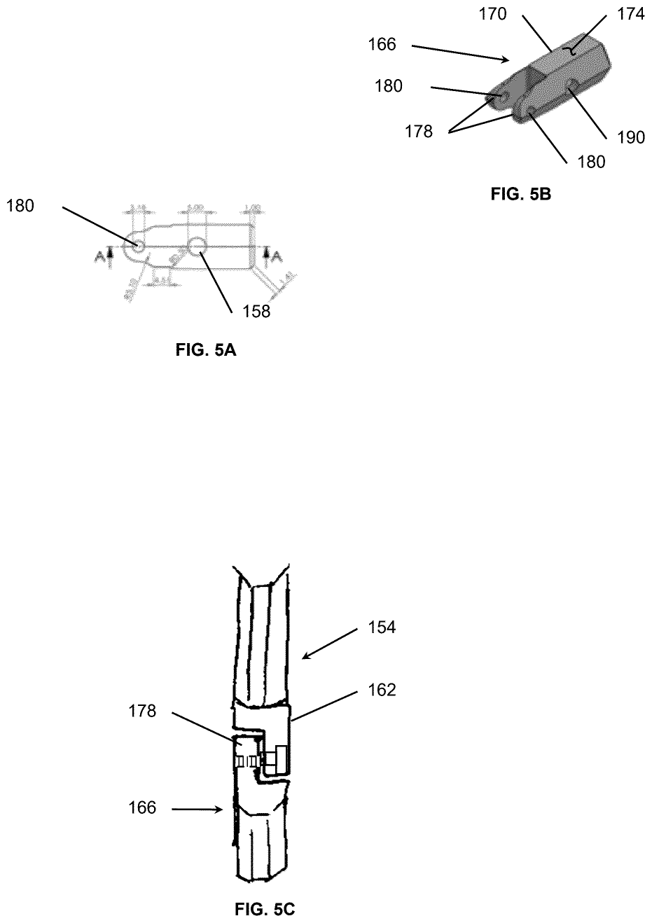

As illustrated in FIGS. 4A-4B, the elongated shaft 124 includes a shaft portion with a drive head 150 on a free end, and an opposite pivoting end 154 having a hole 158 therethrough and a portion 162 with an outer surface corresponding to the cross-sectional shape (e.g., hexagon as illustrated) and size of the interior of the slider housing 132. Pivotably attached to the pivoting end 154 is a sliding joint member 166 as illustrated in FIGS. 5A-5B. Sliding joint member 166 has a main body 170 with an outer surface 174 that also corresponds to the cross-sectional shape and size. The main body 170 has one or more tabs 178, such as opposed tabs, extending from opposite sides of the main body. Each of the tabs 178 has a through-hole 180 along a pivot axis, and the tabs are spaced apart to receive the end of the pivoting end 154 of shaft 124 therebetween. When assembled, pivoting end 154 of shaft 124 is pivotably retained between the tabs by a dowel pin 182 or a shoulder screw passing through the tab holes 180 and hole 158. While such a configuration is illustrated in detail by the sliding joint member of FIGS. 5A-5B, it will be appreciated that an alternative assembly, as depicted in FIG. 5C, may also be employed. For example, FIG. 5C depicts a single tab 178, with a locking screw or similar fastener having a non-threaded shoulder passing through and is threadedly engaged in a threaded hole in the tab 178, or vice-versa.

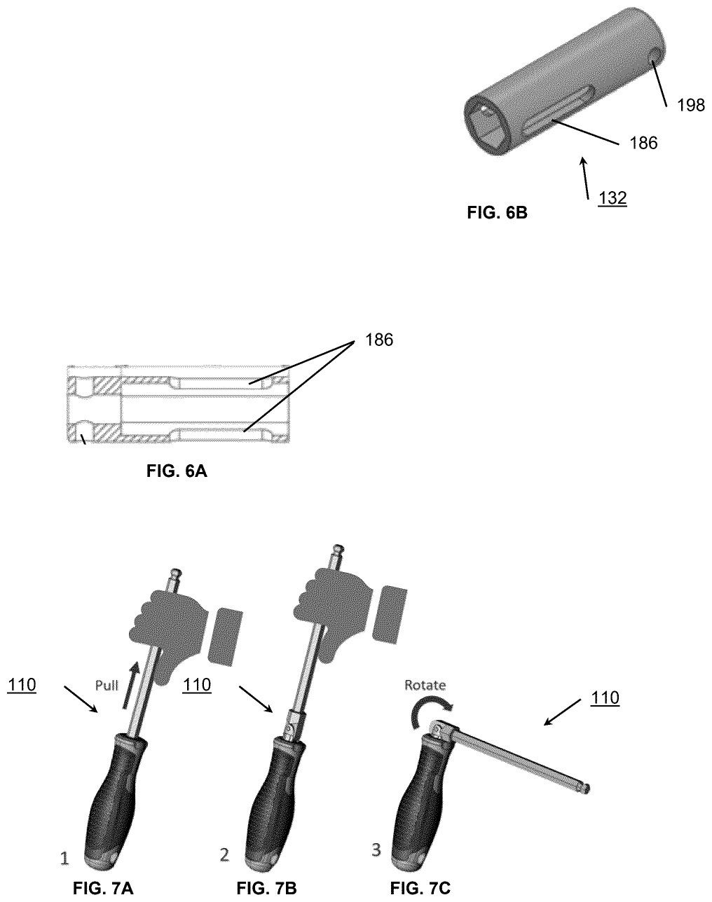

The slider housing 132, illustrated in FIGS. 6A-6B, further includes a pair of parallel slots 186 in opposing walls thereof, and the sliding joint member 166 includes a second through-hole 190 in its main body 170, and the driver further includes at least a second dowel pin 194 inserted into the second through-hole 190 and extending outward from opposite sides of the sliding joint member 166 into the parallel slots 186 to retain the sliding joint member in a sliding relationship within the slider housing. And the slider housing 132 further includes a through-hole 198 therein, where the resilient member, such as the coil spring 128 is attached between the second dowel pin 194 and a third dowel pin 206 inserted into the through-hole 198 in the slider housing. The resilient member or spring 128 serves to both retain the sliding joint member in sliding contact with the slider housing, and to bias or retract the sliding joint member 166 and shaft 124 when pulled or extended from the handle.

When the sliding joint member 166 and connected shaft portion 124 are fully retracted, the slider housing is in operational contact with the hexagonal surfaces of both, thereby transferring a rotational force applied to the handle to the shaft.

It should also be appreciated that in an alternative configuration, such as that depicted in FIG. 3B, a compression-type coil spring 128 may be employed instead of the tension spring. As illustrated in the embodiment of FIG. 3B, a compression-type coil spring 128 is placed around a stem 130 to provide the biasing and retractive force that is transferred through the slider housing 132 to sliding joint member 166.

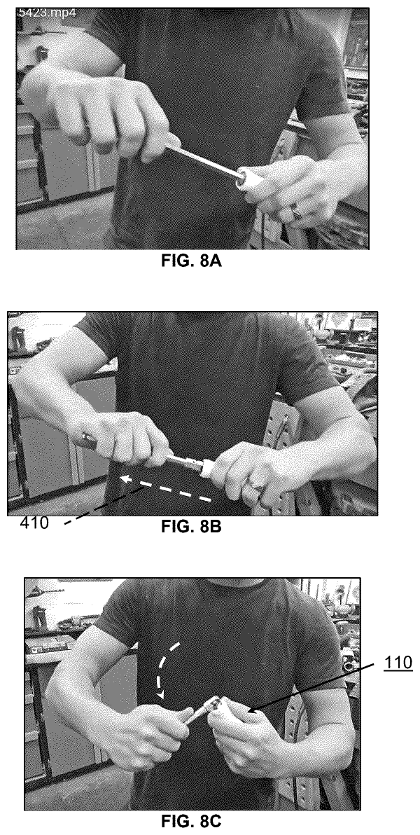

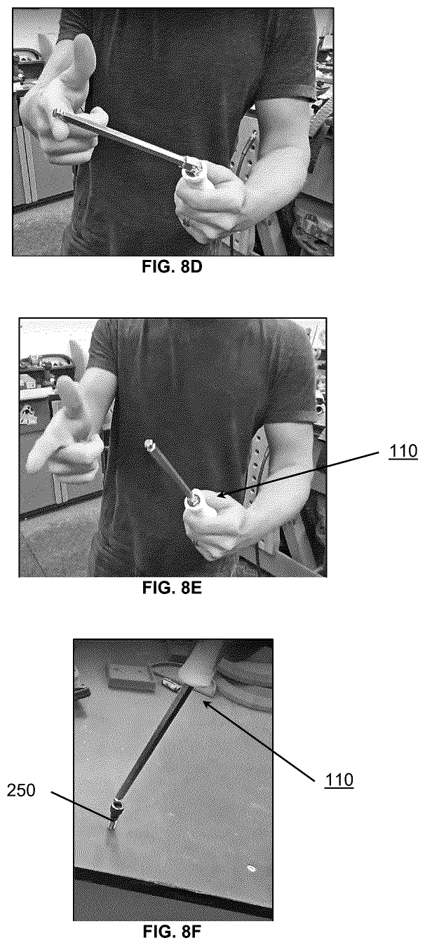

FIGS. 7A-7C are illustrations of the functionality of the pivoting driver 110. The successive figures show the basic steps to change from the driver being in its co-linear configuration of FIG. 7A, by first pulling the elongated shaft away from the handle, applying a bending force as depicted in FIG. 7B, to then have the shaft pivoted or rotated relative to the handle as depicted in FIG. 7C. These operations are now described in more detail relative to FIGS. 8A-8H.

Turning to FIGS. 8A-8H, a series of sequential configurations of an exemplary pivoting driver are illustrated. In FIG. 8A, the pivoting driver 110 is shown in its retracted position. Pulling the driver in the direction of arrow 410 in FIG. 8B removes the pivoting end 154 of shaft 124 from the confines of slider housing 132 and allows the shaft 124 to be pivoted relative to handle 118 as shown in FIG. 8C. To return the pivoting driver to its retracted position one need only to move the shaft toward co-linear alignment with the handle, as depicted in FIG. 8D, and the biasing tension spring 128 will then pull the shaft back into the slider housing 132 of handle 118 as shown in FIG. 8E.

FIGS. 8F and 8G illustrate the use of the pivoting driver 110 to engage and then tighten a fastener such as cap screw 250. And FIG. 8H shows the pivoting driver 110 with its handle 118 in the pivoted position in order to apply a greater force to tighten or loosen the fastener.

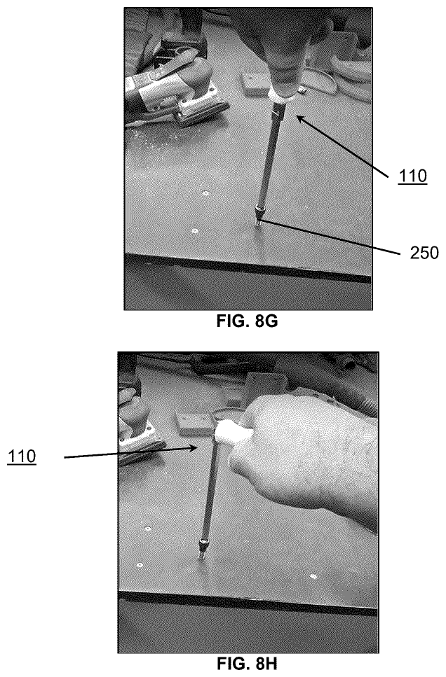

Referring briefly to FIGS. 9A-11B, depicted therein are alternative embodiments to achieve a pivoting driver. In FIGS. 9A-9B, the shaft 124 is not retractable within the handle 118, but is still pivotably connected to the handle at pivot 310. The handle is maintained in the straight position (FIG. 9B) or pivoted position (e.g., 90-degrees as in FIG. 9A) by a small ball or similar mechanism 320 that is biased against the pivoting end of the shaft by a spring 330, and the ball 320 moves into detents 334 when they align with the ball 320. The ball-detent combination serves to “hold” the shaft in a position until force is applied about the pivot pin to overcome the force of the spring and allow the shaft 124 to pivot.

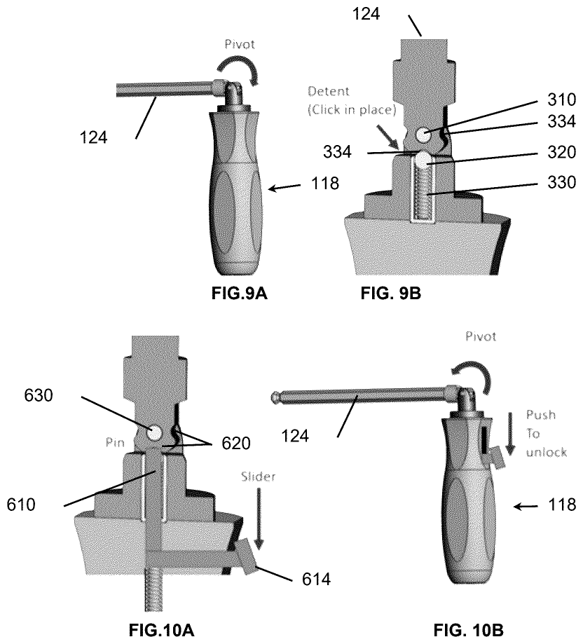

In a manner similar to FIGS. 9A-9B, the embodiment of FIG. 10A-10B also includes a shaft 124 that pivots relative to handle 118, but in the illustrated embodiment the shaft 124 is held in either its co-linear or angled (pivoted) position by a sliding member 610 that is moved, between an extended position that engages a recess 620 in the pivoting end of shaft 124, and a retracted position (not shown) that allows the shaft to freely pivot about pivot pin 630. Sliding member 610 is operatively attached to a “button” or “trigger” 614 that controls the position of the sliding member between an extended or engaged (locked) position (FIG. 10A) and a retracted or disengaged (unlocked) position. It will be appreciated that various alternative mechanisms may be used to operatively control the position of sliding member 610, including direct mechanical connection, mechanical linkages, cables, screw/twist, etc.

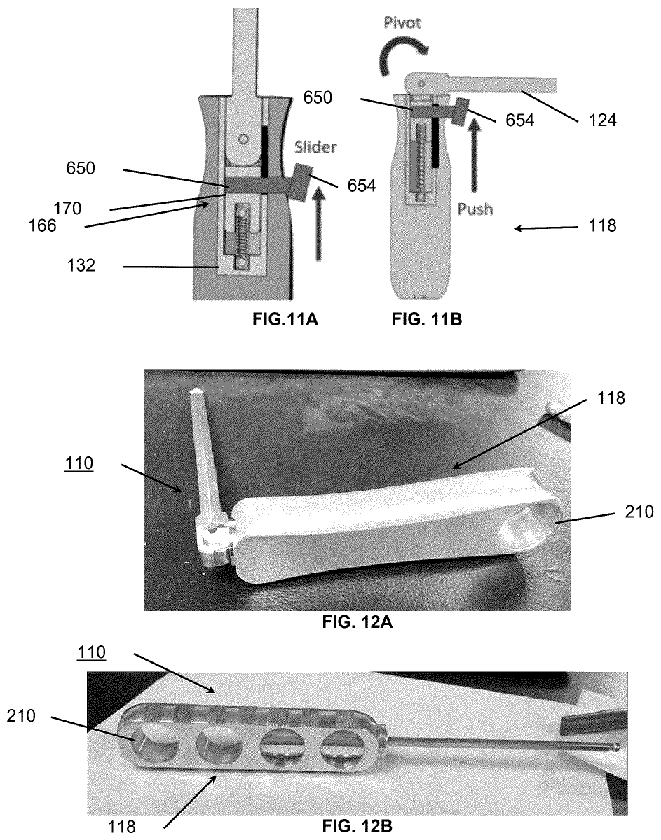

Turning to FIGS. 11A-11B, an alterative embodiment is illustrated to facilitate the extension/retraction of shaft 124 relative to handle 118. More specifically a mechanical member such as a slider 650 is shown as extending inwardly from an outer surface of handle 118 where it is operated by a thumb-button or similar component 654. Moving of thumb-button 654 moves slider 650, which in turn allows the shaft 118 and its associated pivot components (e.g., sliding joint member 166) to move between a retracted position where the shaft is co-linear (e.g., FIG. 11A), to an extended position where the shaft may be pivoted relative to the handle (e.g., FIG. 11B). As illustrated, the slider 650 extends into the interior of handle 118, possibly through a slot(s) 186 of slider housing 132, where it is in operational contact with a modified configuration of the sliding joint member 166 and its main body 170.

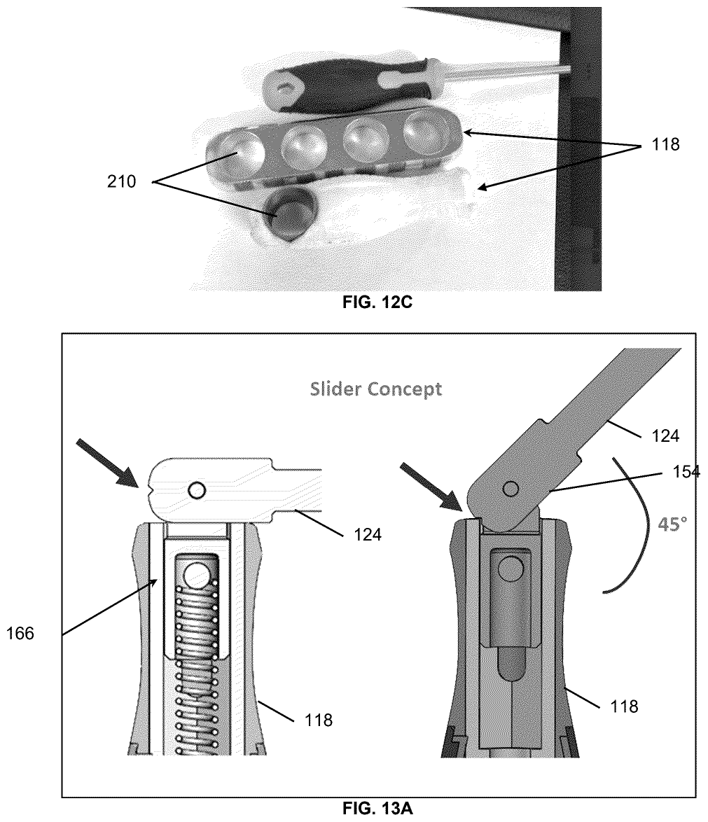

In one embodiment, the handle of pivoting driver 110 may also include at least one through-hole 210, such as depicted in FIGS. 12A-12C . The hole 210 is oriented perpendicular to a longitudinal axis of the handle but parallel to the shaft portion 124 when pivoted at +/−90°, so that a user may use a finger or thumb inserted into handle 118 to “speed-turn” the shaft 124 of the driver when a fastener provides low resistance.

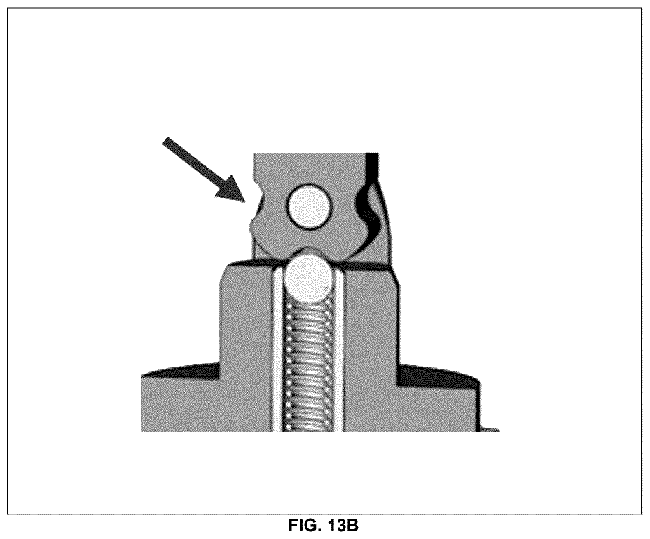

Turning next to FIGS. 13A-13C, depicted therein are alternative configurations for the pivoting driver, where alternative features and geometries on the shaft and/or the handle such as indentations, cut-outs, or detents are used to releasably hold the shaft in a fixed position at alternative or even infinite angles over a 180-degree range between −90° to +90°. On example of the use of alternative geometries to control the various angular positions that the shaft may take is illustrated in these figures. In FIG. 13A, the outer edge of the shaft pivoting end 154 are, in a +/−90° position, held in contact with the end of the handle 118 (e.g., slider housing 132) by spring 128. At a 45° angle, it could be contact with a detent or notch in the bottom edge of the shaft pivoting end 154. It will be appreciated that multiple notches or detents may be used to retain the shaft at various angles relative to the handle. The multiple angle locking feature is also provided by the ball-detent and pin-hole embodiments illustrated in FIGS. 13B and 13C, respectively. Another option (not illustrated) is that one or both of the interacting surfaces of the tab(s) 178 and pivoting end 154 of shaft 124 each have radial ridges or grooves thereon and a biased ball or other member that impinges the grooves or ridges to hold the shaft at different angles. It is also possible that the surfaces of the tab(s) 178 and pivoting end 154 each themselves are biased toward one another and their respective grooves interact with ridges at various angles.

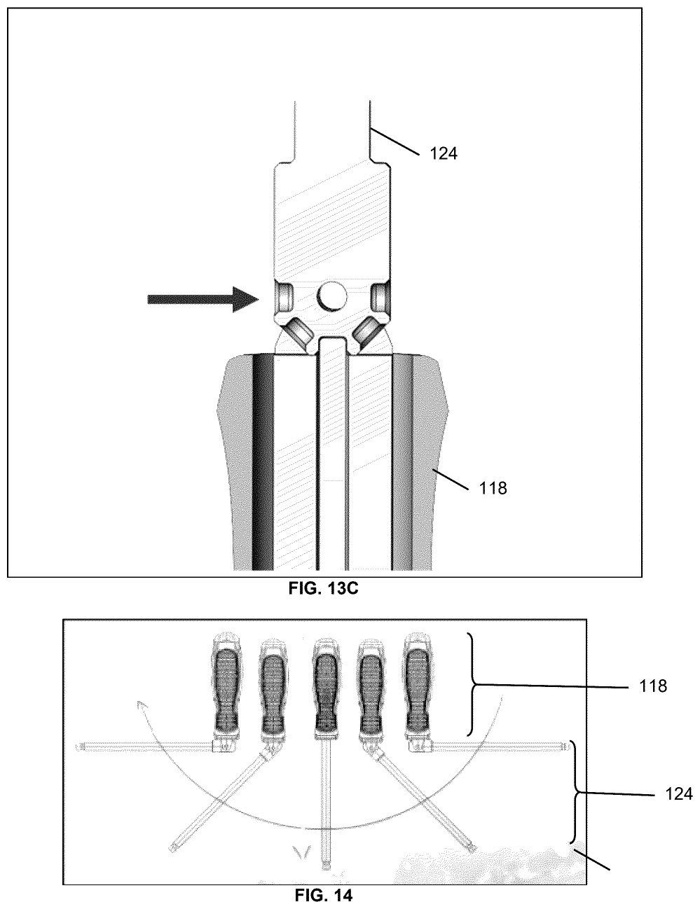

As further illustrated in FIG. 14, the five sequential views of the pivoting driver are used to represent, as characterized by the arrow, the various operational configurations of the pivoting driver, where the shaft 124 is operatively pivoted through a 180-degree range of positions relative to handle 118.

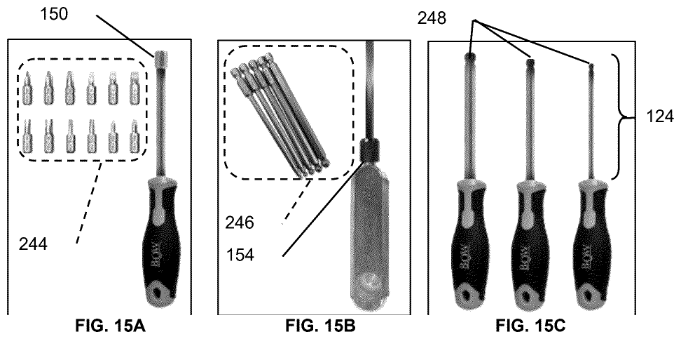

FIGS. 15A-15C illustrate several alternative embodiments that include associated components of the pivoting driver. In FIG. 15A, the drive head 150 includes a receptacle (e.g., a recessed hole having a hex-shaped cross section) for receiving a removable bit therein, such as the conventional hex-shaft bits 244 shown for illustration in the upper left of the figure. In one embodiment, the drive head receptacle is a magnetic bit holder. As illustrated in the embodiment of FIG. 15B, the elongated shaft 124 includes a quick-release receptacle near the pivoting end 154 for receiving a removable bit 246 therein. Finally, FIG. 15C shows an embodiment where each driver is a different size (diameter) shaft 124, and a corresponding ball-end hex head 248 at the end.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A hand-held driver including:
an elongated handle; and
an elongated shaft pivotably connected to and extending from the handle;
wherein the handle can be used to apply torque to the shaft in both a first orientation along a longitudinal axis of the shaft and a second orientation generally perpendicular to the longitudinal axis of the shaft.

2. The driver according to claim 1, wherein the elongated shaft is slidably inserted into the handle.

3. The driver according to claim 1, wherein the elongated shaft is retained within the handle by a biasing member.

4. The driver according to claim 1, wherein the handle includes a slider housing, the outside of which is affixed to the handle, and the inside of which has a cross-sectional shape defined by a plurality of adjacent planar surfaces; and
wherein the elongated shaft includes:
a shaft portion with a drive head on a free end, and an opposite pivoting end having a hole therethrough and a portion with an outer surface corresponding to the cross-sectional shape;
a sliding joint member having a main body with an outer surface corresponding to the cross-sectional shape, the main body having extended tabs on opposite sides, each of the tabs having a through-hole along a pivot axis; and
a dowel pin for pivotably connecting the pivoting end of the shaft portion and the sliding joint member.

5. The driver according to claim 4, wherein the slider housing further includes at least one slot or a pair of parallel slots in opposing walls thereof and where the sliding joint member includes a second through-hole in the main body; and where the driver further includes at least a second dowel pin inserted into the second through-hole and extending into the at least one or both of the parallel slots to retain the sliding joint member in sliding contact with the slider housing.

6. The driver according to claim 5, wherein the slider housing further includes a through-hole therein and where a resilient member (spring) is attached between the second dowel pin and a third dowel pin inserted into the through-hole in the slider housing, the resilient member serving to retain the sliding joint member in sliding contact with the slider housing, and to bias (retract) the sliding joint member when extended.

7. The driver according to claim 6, wherein when the sliding joint member and connected shaft portion are fully retracted, the slider housing is in operational contact with the surfaces of both, thereby transferring any force applied to the handle to the shaft.

8. The driver according to claim 5, wherein the slider housing further includes a resilient member (spring) that is in compression to both retain the sliding joint member in sliding contact with the slider housing, and to bias (retract) the sliding joint member when extended.

9. The driver according to claim 4, wherein the handle further includes:
a partially hollow main handle to which the slider housing is affixed in a first end; and
a bottom handle that covers a portion of the main handle including a second end opposite the first end.

10. The driver according to claim 9, further including a grip surface.

11. The driver according to claim 10, wherein the grip surface includes a rubber overmolding applied over the main handle and bottom handle.

12. The driver according to claim 5, wherein the handle includes a through-hole.

13. The driver according to claim 5, wherein, the through-hole is oriented perpendicular to a longitudinal axis of the handle.

14. The driver according to claim 4, where the drive head includes a receptacle for receiving a removable bit therein.

15. The driver according to claim 15, where the receptacle is a magnetic bit holder.

16. The driver according to claim 1, where the elongated shaft includes a quick release receptacle for receiving a removable bit therein.
